(19) United States
(12) Patent Application Publication
(10) Pub. No.: US 2005/0072864 A1
(43) Pub. Date: Apr. 7, 2005

(54) Fuel Injection valve

(76) Inventors: Fevzi Yildirim, Gerlingen (DE); Guenther Hohl, Stuttgart (DE); Michael Huebel, Gerlingen (DE); Norbert Keim, Loechgau (DE)

Correspondence Address: KENYON & KENYON, ONE BROADWAY, NEW YORK, NY, 10004, US

(21) Appl. No.: 10/204,865

(22) PCT Filed: Dec. 15, 2001
(86) PCT No.: PCT/DE01/04751

(30) Foreign Application Priority Data
Dec. 19, 2000 (DE) 100 63 259.9

(51) Int. Cl. B05B 1/30

(52) U.S. Cl. 239/585.1

(57) ABSTRACT

A fuel injector, particularly for direct injection of fuel into a combustion chamber of a mixture-compressing, spark-ignited internal combustion engine, includes an actuator, a valve needle actuatable by the actuator for actuation of a valve-closure member, which, together with a valve-seat surface forms a sealing seat, and a swirl disk which has at least one swirl channel. An elastic membrane is arranged upstream from the swirl disk in such a way that a metering cross-section of the at least one swirl channel is variable as a function of the fuel pressure prevailing in the fuel injector during operation.

### FIELD OF THE INVENTION

The present invention relates to a fuel injector.

### BACKGROUND INFORMATION

A fuel injector for direct injection of fuel into the combustion chamber of a mixture-compressing, spark-ignited internal combustion engine which, on the downstream end of the fuel injector, has a guide and seat area which is formed from three disk-shaped elements is known from German Published Patent Application No. 197 36 682. A swirl element is embedded between a guide element and a valve seat element. The guide element guides an axially movable valve needle penetrating through it, while a valve closing section of the valve needle cooperates with a valve-seat surface of the valve seat element. The swirl element has an inner opening area containing a plurality of swirl channels which are not connected to the outer periphery of the swirl element. The entire opening area extends fully over the axial thickness of the swirl element.

A particular disadvantage of the fuel injector known from the aforementioned document is the fixedly set swirl angle which cannot be adjusted to the different operating conditions of an internal combustion engine, such as partial load and full load operation. As a result, the cone opening angle of the injected mixture cloud also cannot be adjusted to the different operating conditions, which in turn results in inhomogeneities during combustion, increased fuel consumption, as well as increased exhaust gas emission.

### SUMMARY OF THE INVENTION

The fuel injector according to the present invention has the advantage over the related art that the swirl is adjustable as a function of the operating state of the engine, whereby a jet pattern may be produced which is adapted to the operating state of the engine, resulting in an optimization of the mixture formation and the combustion process.

The jet opening angle is advantageously influenced via the pressure of the fuel streaming through the fuel injector; the pressure causes a cross-section change of the swirl channels via an elastic membrane according to the operating condition and thereby directly influences the swirl intensity.

The design of the membrane in the form of a disk-shaped membrane, which is situated between the swirl disk and a guide disk, is particularly advantageous. This embodiment is manufacturable in a particularly easy and cost-effective manner and is applicable to any shape of swirl disks.

It is a further advantage that the disk-shaped membrane is connected to the outside of the guide disk, thus preventing losses through leakage.

The membrane may also advantageously be designed as an elastic layer, which may be arranged on any side face of the swirl channel.

### BRIEF DESCRIPTION OF THE DRAWINGS

FIG. 1 shows an axial section through an exemplary embodiment of a fuel injector according to the present invention.

FIG. 2 shows a schematic view of an exemplary swirl disk of a fuel injector designed according to the present invention, illustrated in FIG. 1.

FIG. 3 shows a schematic view of a swirl channel of the swirl disk illustrated in FIG. 2.

FIG. 4a shows a first schematic illustration of the mode of operation of the first and a second embodiment of a membrane situated on the swirl disk.

FIG. 4b FIG. 4a shows a second schematic illustration of the mode of operation of the first and a second embodiment of a membrane situated on the swirl disk.

### DETAILED DESCRIPTION

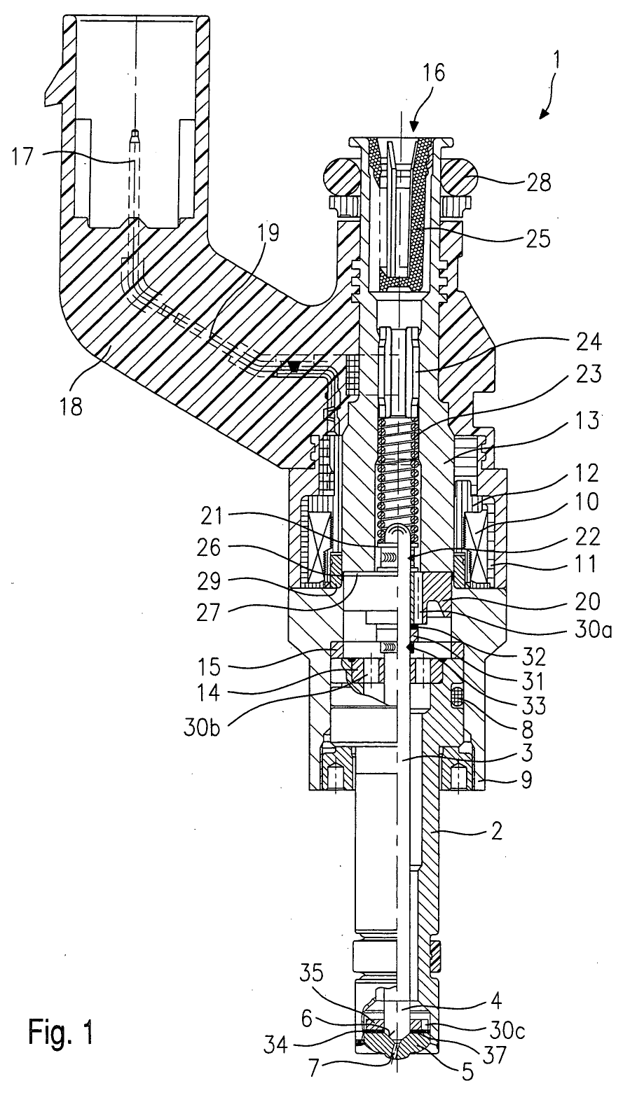

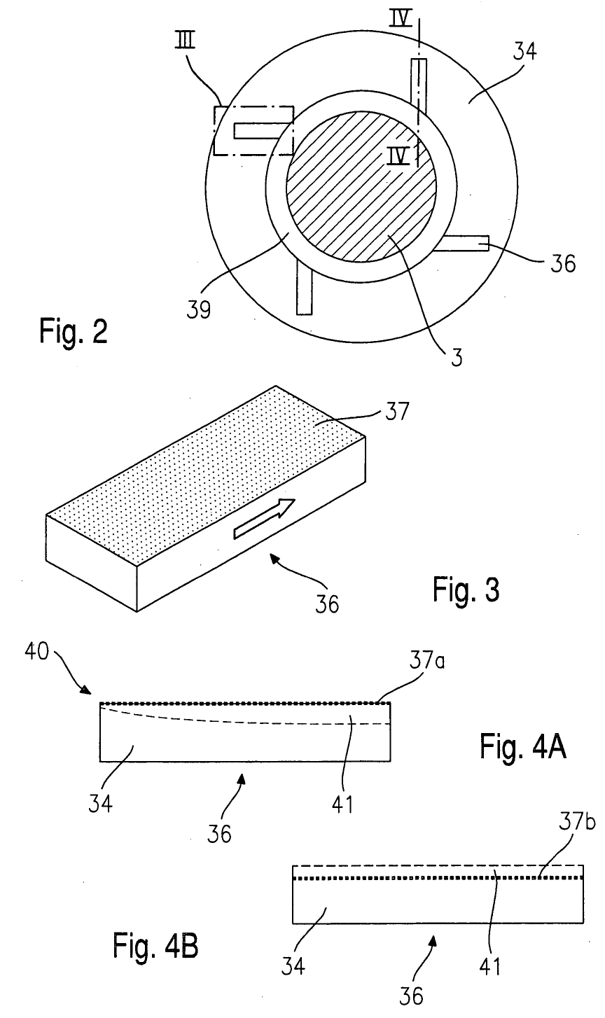

Before describing exemplary embodiments of a fuel injector 1 according to the present invention in greater detail on the basis of FIGS. 2 through 4, fuel injector 1 according to the present invention is briefly explained in an overall description with regard to its components, on the basis of FIG. 1, for better understanding of the present invention.

Fuel injector 1 is configured in the form of a fuel injector for fuel injection systems of mixture-compressing, spark-ignited internal combustion engines. Fuel injector 1 is particularly suitable for direct injection of fuel into a combustion chamber (not shown) of an internal combustion engine.

Fuel injector 1 includes a nozzle body 2 in which valve needle 3 is situated. Valve needle 3 is mechanically linked to a valve-closure member 4, which cooperates with a valve-seat surface 6, situated on a valve seat body 5 to form a sealing seat. Fuel injector 1 in the exemplary embodiment is an inwardly opening fuel injector 1 which has at least one spray-discharge orifice 7. Nozzle body 2 is sealed by a gasket 8 against external pole 9 of a magnetic circuit. A solenoid 10 is encapsulated in a coil housing 11 and is wound on a field spool 12 which rests on an internal pole 13 of the magnetic circuit. Internal pole 13 and external pole 9 are separated from one another by a gap 26 and are supported by a link component 29. Solenoid 10 is energized by an electric current supplied via an electric plug-in contact 17 over a line 19. Plug-in contact 17 is enclosed by a plastic coating 18 which may be extruded onto internal pole 13.

Valve needle 3 is guided in a valve needle guide 14 which has the shape of a disk. A matching adjusting disk 15 is used for lift adjustment. An armature 20 is situated on the other side of adjusting disk 15. The armature is friction-locked to valve needle 3 via a first flange 21, the valve needle being connected to first flange 21 by a weld 22. In the present design of fuel injector 1 a restoring spring 23 is supported on first flange 21 and is under prestress by a sleeve 24.

A second flange 31, which is connected to valve needle 3 by a weld 33, is used as a lower armature stop. An elastic intermediate ring 32 which rests on second flange 31 prevents rebounding when fuel injector 1 is closed.

A guide disk 35 is formed upstream from the sealing seat, the guide disk providing for a central alignment of valve needle 3 and thus counteracting tilting of valve needle 3 and subsequent inaccuracies in the metered fuel amount. A swirl disk 34, having swirl channels 36, is situated between guide disk 35 and valve seat body 5. A membrane 37, preferably made of an elastic material and which is deformable by the system pressure prevailing in fuel injector 1, is situated between guide disk 35 and swirl disk 34. A detailed illustration of membrane 37 and its mode of operation may be obtained from FIGS. 3 and 4.

Fuel channels 30a through 30c run in valve needle guide 14, in armature 20, as well as in guide disk 35. The fuel is supplied via a central fuel supply line 16 and is filtered through a filter element 25. Fuel injector 1 is sealed by a gasket 28 against a fuel supply line which is not further illustrated.

In the idle state of fuel injector 1, armature 20 is acted upon by restoring spring 23 against its lift direction in such a way that valve-closure member 4 is held in sealing contact with valve seat surface 6. When solenoid 10 is energized it generates a magnetic field which moves armature 20 in the lift direction against the elastic force of restoring spring 23, the lift being predetermined by a working gap 27 which in the idle position is situated between internal pole 13 and armature 20. Armature 20 entrains flange 21, which is welded to valve needle 3, also in the lift direction. Valve-closure member 4, which is mechanically linked to valve needle 3, is lifted up from valve-seat surface 6 and the fuel is spray-discharged.

When the coil current is turned off, armature 20 drops back away from internal pole 13 after the magnetic field has decayed sufficiently, due to the pressure of restoring spring 23, so that flange 21, which is mechanically linked to valve needle 3, moves against the lift direction. Valve needle 3 is thereby moved in the same direction, so that valve-closure member 4 comes to rest on valve-seat surface 6 and fuel injector 1 is closed.

FIG. 2 shows a schematic illustration of an exemplary swirl disk 34, which simply and effectively supports membrane 37 according to the present invention and which is described further below. In the present exemplary embodiment swirl disk 34 has four swirl channels 36 which are tangentially offset with respect to a center point of swirl disk 34. The offset of swirl channels 36, as well as their radial length, their number, and their arrangement are arbitrary.

The cross-section of swirl channels 36 is based on the fuel pressure and the requirements for the swirl intensity and may be adapted by simple changes in the width of swirl channels 36 and/or the axial thickness of swirl disk 34, as well as via membrane 37 according to the present invention.

Swirl channels 36 open into swirl chamber 39 which is penetrated by valve needle 3. Swirl chamber 39 should be dimensioned in a way that the swirl flow remains as homogeneous as possible and the dead volume is kept as small as possible.

FIG. 3 shows a detail of swirl disk 34, illustrated in FIG. 2, of fuel injector 1 according to the present invention, in a partial sectional view of area III of FIG. 2.

Swirl channel 36, illustrated in FIG. 3 as a cuboid, for example, has membrane 37 as an end piece covering swirl channel 36, the membrane being similar to a cover plate. Membrane 37 may be arranged between swirl disk 34 and guide disk 35 as a disk-shaped membrane 37a or may be configured in the form of an elastic layer 37b on a face of guide disk 35 facing swirl disk 35. The arrow indicates the flow direction of the fuel. Membrane 37 does not need to be situated between guide disk 35 and swirl disk 34, but may also be situated on any of the radially running side faces 41. The disk-shaped design and the location between swirl disk 34 and guide disk 35 is illustrated as a preferred exemplary embodiment due to the particularly simple form and configuration.

FIGS. 4A and 4B clarify the mode of operation of disk-shaped membrane 37a or of elastic layer 37b. Membrane 37a and layer 37b are illustrated on top of FIGS. 4A and 4B respectively.

FIG. 4A shows the mode of operation of disk-shaped membrane 37a in a schematic form. Swirl channel 36 is shown here in a lateral sectional view along line IV-IV indicated in FIG. 2. Disk-shaped membrane 37a is arranged between swirl disk 34 and guide disk 35 and is glued or welded to a radial outer edge of guide disk 35 in order to prevent losses through leakage.

During operation of fuel injector 1 fuel flows through swirl channel 36 from radially outside to radially inside. Depending on the flow velocity of the fuel, a hydrodynamic pressure of different strengths is generated on disk-shaped membrane 37a, resulting in the membrane being pulled downward and thereby reducing the cross-section of swirl channel 36. This in turn results in an increase of the flow velocity of the fuel. As soon as a balance of forces is achieved the condition is stabilized.

If the fuel flows slowly through a wide cross-section, the swirl flow generated in swirl chamber 39 is weak, whereby a mixture cloud injected into the combustion chamber of the engine has a small jet opening angle. The penetration of the mixture cloud is accordingly high, which corresponds to the requirements regarding the shape and stoichiometry of the mixture cloud.

If the flow velocity is increased, which corresponds to the full load operation of fuel injector 1, disk-shaped membrane 37a experiences a deformation due to a shift in the acting balance of forces, resulting in a decrease of the axial dimension of swirl channel 36. Correspondingly, the velocity of the fuel flowing through swirl channels 36 increases further, thus also increasing the swirl. This results in a widening of the mixture cloud being injected into the combustion chamber, the mixture cloud having a wider jet opening angle and homogeneously filling the combustion chamber with an ignitable mixture.

In a same view as in FIG. 4A, FIG. 4B shows membrane 37 configured as elastic layer 37b. In contrast to FIG. 4A, elastic layer 37b, illustrated in FIG. 4B, is not a loose disk situated between swirl disk 34 and guide disk 35, but is designed in the form of elastic layer 37b, formed on the downstream face 38 of guide disk 35 and being connected to guide disk 35 over its entire extent.

The mode of operation is the reverse of the exemplary embodiment illustrated in FIG. 4A. If the fuel pressure in fuel injector 1 increases during operation, elastic layer 37b is deformed against the flow direction, resulting in greater cross-sections of swirl channels 36. This is due to the fact that elastic layer 37, being fixedly connected to downstream face 38, is displaced or compressed during an increase of the fuel pressure.

The present invention is not limited to the illustrated exemplary embodiments, but is also applicable particularly in fuel injectors 1 having piezoelectric or magnetostrictive actuators 10, and any form of swirl disks 34 having any form of swirl channels 36.

1-8. canceled

9. A fuel injector, comprising:
an actuator;
a valve-closure member;
a valve-seat surface;
a valve needle that is actuatable by the actuator for actuating the valve-closure member, the valve-closure member and the valve-seat surface forming a sealing seat;
a swirl disk having at least one swirl channel; and
an elastic membrane situated on the swirl disk such that a metering cross-section of the at least one swirl channel is variable as a function of a fuel pressure prevailing in the fuel injector during operation.

10. The fuel injector as recited in claim 9, wherein:
the fuel injector is for direct injection of a fuel into a combustion chamber of a mixture-compressing, spark-ignited internal combustion engine.

11. The fuel injector as recited in claim 9, wherein:
the elastic membrane forms at least one side face of the at least one swirl channel.

12. The fuel injector as recited in claim 9, wherein:
the elastic membrane includes a disk-shaped membrane.

13. The fuel injector as recited in claim 12, further comprising:
a guide disk situated upstream from the swirl disk, wherein:
the disk-shaped membrane is situated between the swirl disk and the guide disk.

14. The fuel injector as recited in claim 13, wherein:
the disk-shaped membrane is connected to the guide disk on at least one radial outer edge.

15. The fuel injector as recited in claim 13, wherein:
a cross-section of the at least one swirl channel decreases with an increase of the fuel pressure due to the disk-shaped membrane.

16. The fuel injector as recited in claim 9, wherein:
the elastic membrane includes an elastic layer.

17. The fuel injector as recited in to claim 16, wherein:
a cross-section of the at least one swirl channel increases with an increase of the fuel pressure due to the elastic layer.
